(19) United States
(12) Patent Application Publication
(10) Pub. No.: US 2012/0297423 A1
(43) Pub. Date: Nov. 22, 2012

(54) Method and system for program and stream control of video to target device

(75) Inventors: Chaitanya Kanojia, West Newton, MA (US); Joseph Thaddeus Lipowski, Norwell, MA (US)

(73) Assignee: AEREO, INC., Long Island City, NY (US)

(21) Appl. No.: 13/399,690

(22) Filed: Feb. 17, 2012

Related U.S. Application Data
(60) Provisional application No. 61/444,427, filed on Feb. 18, 2011.

(51) Int. Cl. H04N 21/482

(52) U.S. Cl. 725/48; 725/39

(57) ABSTRACT

An approach to enable users to control and direct video from streaming video sources uses target devices for displaying video selected on control devices. The switching and control path is provided in the cloud, i.e., by the streaming video source. Further described is an approach to mirror the content displayed on the control device to the target device. In this way, viewers other than the operator of the control device can view available video lists and thus take part in the video selection process.

### RELATED APPLICATIONS

This application claims the benefit under 35 USC 119(e) of U.S. Provisional Application No. 61/444,427, filed on Feb. 18, 2011, which is incorporated herein by reference in its entirety.

### BACKGROUND OF THE INVENTION

Video, and the corresponding audio, content are typically provided to display devices such as televisions via set top boxes supplied by cable or satellite providers. The set top boxes demodulate and decode incoming signals to produce video and audio signals compatible with standard interfaces commonly provided on televisions, such as composite video and audio, component audio and video, and HDMI (High Definition Multi-Media Interface), to list a few examples. The Thunderbolt interface is another example. The demodulated and decoded signals are then transmitted to the display devices on interface cables.

An alternate method for supplying content to televisions is to access Internet video streaming sources such as NETFLIX.COM or HULU.COM. Further, all of the major television networks have their own web sites that also function as streaming video sources. Still others provide user generated content, such as YOUTUBE.COM. The video can be supplied to the television via streaming media devices. Two examples are the Roku streaming player by Roku Inc. and the Apple TV media receiver by Apple Inc. And many game consoles have the ability to access streaming video content through proprietary program interfaces, via third-party software such as provided by Netflix, Inc., and via embedded browsers. Typically, the streaming media devices connect to the Internet and provide streaming video content from the Internet streaming sources to televisions or other display devices using the standard interfaces, like the set top boxes. Further some televisions have network connections and embedded browsers to directly access media on the Internet.

At the same time these Internet streaming video sources can be accessed in the traditional fashion using personal computers, tablet/slate computers, and smartphones via application programs such a browsers or proprietary programs distributed by the sources.

### SUMMARY OF THE INVENTION

A perennial problem with televisions and the associated devices is controlling the different devices. There is often one remote control for the television and another for each set top box and still another for the streaming media device. While the number of required remotes can be reduced with universal remotes, they are often difficult to set up. Moreover, navigation and control is often difficult because these universal remotes generally lack a keyboard. On the other hand, portable computing devices such as tablet/slate computer and smartphones are becoming ubiquitous.

The present system and method concern an approach to enable users to control and direct video from the streaming video sources. The method and system provides for target devices for displaying video selected on control devices. The switching and control path is provided in the cloud, i.e., by the streaming video source.

The present system and method also concern an approach to mirror the content displayed on the control device to the target device. In this way, viewers other than the operator of the control device can view available video lists and thus take part in the video selection process.

In general, according to one aspect, the invention features, a method for program and stream control of video. It comprises displaying on devices, which are registered to accounts of users of a streaming video source, lists identifying video that is available to the users and enabling the users of the devices to select from the available video and to select target devices on which the selected video is to be displayed. The streaming video source then sends the selected video to the selected target devices.

In embodiments, the selection of the target devices is from lists of registered devices corresponding to accounts of the users.

Also, in some embodiments, user interface content displayed on control devices, including the lists of available video, is mirrored to the target devices, such as by converting HTML data to a streaming video format that is then streamed to the target devices.

In some embodiments, the target devices continually communicate with the streaming video source to maintain active connections between the target devices and the streaming video source. This allows the streaming video source to identify the target devices that are available for selection based on the active connections between the target devices and the streaming video source.

In general, according to another aspect, the invention features a system for program and stream control of video. The system comprises a streaming video source that provides streaming video, the streaming video source maintaining accounts for users in which registered devices of the users are associated with each of the accounts. Target devices, which are registered devices, display the streaming video and control devices, which are registered devices, are used by the users to select the streaming video and the target devices.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A is a block diagram illustrating the relationship between a streaming video source and user display devices and specifically the user interface displayed on the control device that enables users to select content, e.g., television programs, for streaming and a target device to receive to the selected content.

FIG. 1B is a block diagram illustrating how the content is selected and streamed from the streaming video source to the selected target device.

FIG. 1C is a block diagram illustrating the video control user interface that is displayed on the control device while the selected content is streamed to the target device.

FIG. 2 is a flow diagram illustrating the steps for selecting the target device and the content to stream to the target device.

FIG. 3A is a block diagram illustrating the relationship between a streaming video source and user display devices and specifically user selection of a target device to receive the mirrored user interface content from the control device.

FIG. 3B is a block diagram illustrating how user interface content displayed on the control device is also streamed to be mirrored on the target device.

FIG. 3C is a block diagram illustrating how the selected content is accessed and streamed from the streaming video source to the selected target device.

FIG. 3D is a block diagram illustrating the video control user interface that is displayed on the control device while the selected content is streamed to the target device.

FIG. 4A is a flow diagram illustrating the steps for selecting the target device, mirroring user interface content, and then streaming the content to the target device.

FIG. 4B is a flow diagram illustrating the steps for mirroring the user interface of the control device to the target device.

FIG. 5 is a block diagram illustrating a system for the capture and distribution of terrestrial television content transmissions.

FIG. 6 illustrates the database architecture for storing content data from available video.

FIG. 7 illustrates the database architecture for the user account database.

### DETAILED DESCRIPTION OF THE PREFERRED EMBODIMENTS

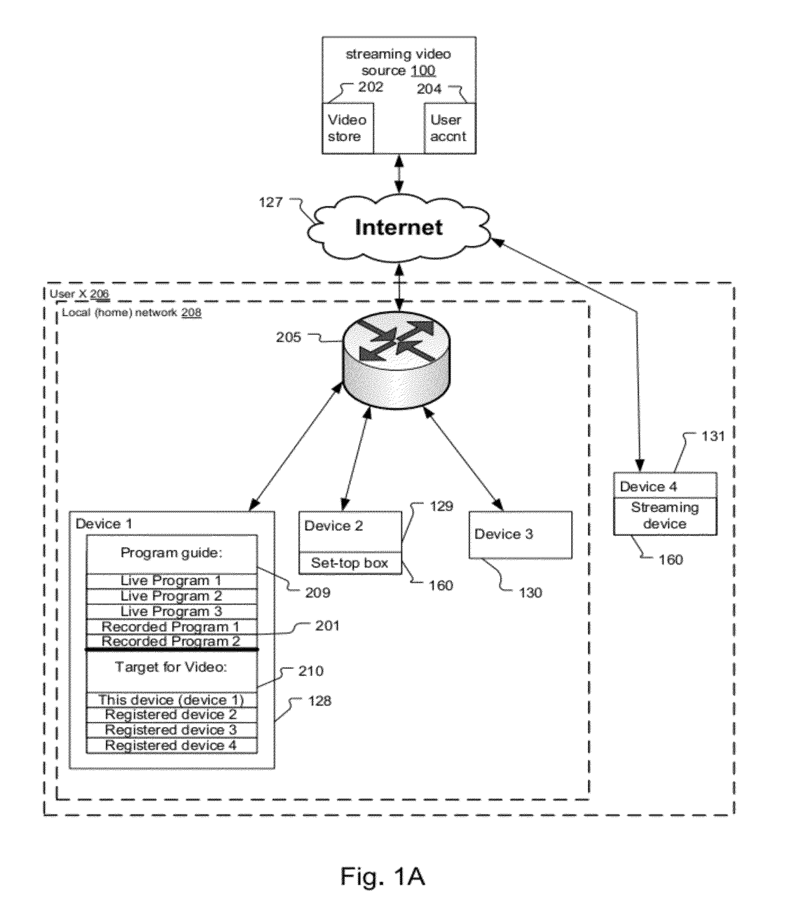

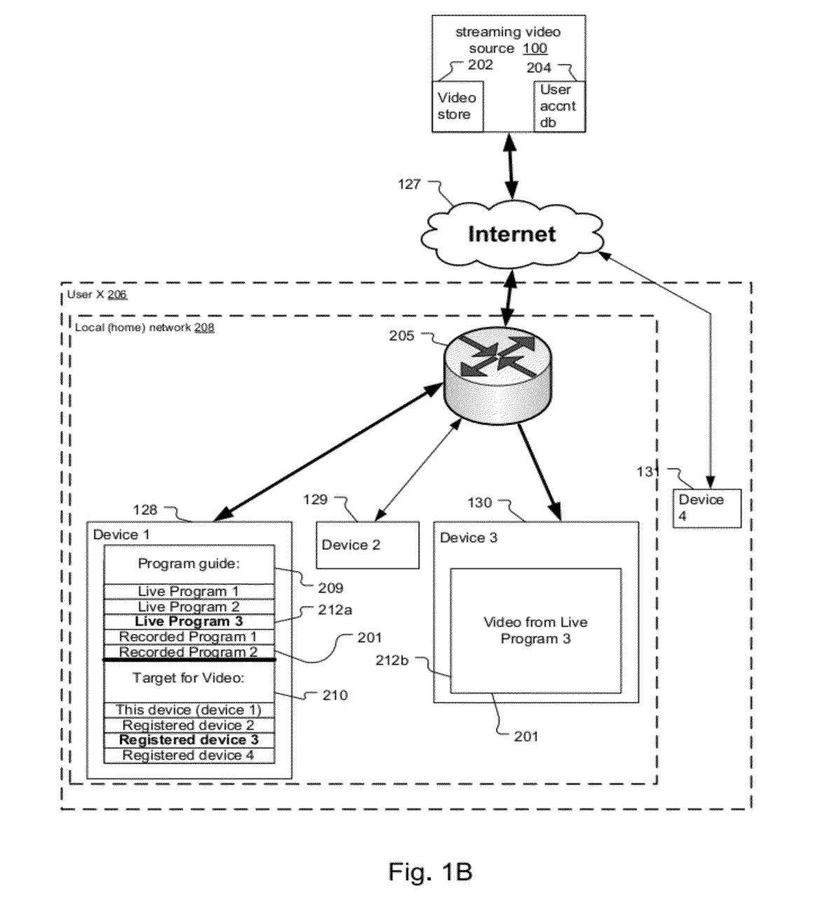

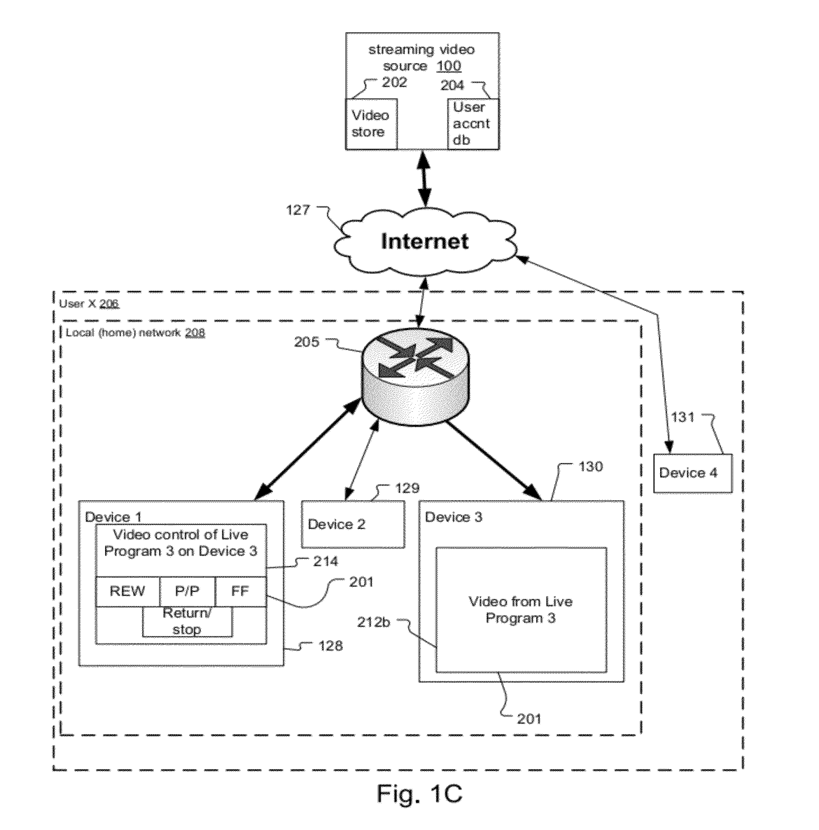

FIG. 1 is a block diagram showing the relationship between the streaming video source 100 and the display devices 128-131 associated with a user (User X) 206.

In one example, the streaming video source 100 is web site or Internet connected source of streaming video. Examples of such sources include NETFLIX.COM, HULU.COM, YOUTUBE.COM, and the web sites provided by a major television network, to list a few specific examples. These sources provide television like programming and in many cases offer television programs that are otherwise provided as terrestrial television broadcasts.

In another example, the streaming video source 100 is a platform and portal that offers video programming from over the air broadcasts from broadcasting entities such as television networks that are captured using an antenna or array of antennas. Typically, the captured over the air broadcasts are decoded, stored and streamed to devices. One example of a television streaming service is described in U.S. patent application Ser. No. 13/299,186, filed on Nov. 17, 2011 by Kanojia and Lipowski, now U.S. Pat. Appl. Publ. No. (“System and Method for Providing Network Access to Antenna Feeds”), which is incorporated herein by reference in its entirety.

These streaming video sources 100 are accessed either directly on personal computers, tablet/slate computers, smartphones via application programs such a browsers or proprietary programs distributed by the sources or via streaming media devices. Additionally, some televisions now have network connections and run embedded browsers to access the Internet. Some of these sources are open access whereas others require a subscription. Some provide different levels of access for paid and non-paying subscribers.

The illustrated example shows the case of a single user accessing the streaming video source 100. This is thus illustrative, however, as many users access the source 100 simultaneously with their own accounts and arrays of registered devices.

As illustrated, four devices 128, 129, 130, and 131 access the streaming video source 100 via the Internet 127. In the example, some of the devices 128, 129, 130 access the internet via a router 205. Typically, the router 205 performs network address translation (NAT) on all incoming and outgoing packet data of the local network 208. Network address translation is the process of changing the Internet protocol (IP) address information of the packet data from non-routable IP addresses used by the local area network 208 to a routable IP address of the router 205 (and vice versa). The routable IP address is the public address of the router 205 on the Internet and is typically assigned by an Internet service provider. The non-routable IP addresses are private addresses assigned to the client devices on the local network 208 by the router 205.

To ensure that network traffic reaches its intended destination, the router 205 utilizes a network address translation table that maintains records of which non-routable IP addresses are assigned to which of the devices on the network 205. This allows the router 205 to map the devices with their non-routable IP addresses to ensure that network traffic from the Internet is directed to the correct device within the local network.

In a typical example, each of these devices 128, 129, 130, and 131 has the capability of displaying streaming video from the streaming video source 100. In a specific example, device 1 128 is a smart phone or tablet mobile computing device. Device 2 and device 4 are televisions that receive streaming media directly via a network interface or via set-top boxes or streaming media devices 160. Device 3 130 also has the capability of displaying streaming video, such as a personal computer.

In one specific example, at least some of the devices 128-131 are mobile devices such as a tablet, e.g., iPad, mobile computing device, or a mobile phone, e.g., iPhone, mobile computing device or mobile computing devices running the Android operating system by Google, Inc.

Each of these devices 128-131 is a registered device in the account of user X 206. In the illustrated example some of the devices 128, 129, 130 are on a common, home local area network 208. Device 131 is also Internet accessible but is not located on the home network 208 in the specific illustrated example.

The streaming video source 100 maintains the statuses and the Internet protocol (IP) addresses of the devices 128-131, in a user account database 204. Along with other account information, the database 204 stores the registered devices and the locations or addresses of the register devices for each user account.

The streaming video source 100 also includes a video store 202 that stores the content data associated with the video that is streamed to the devices 128-131.

The streaming video source 100 transfers the streamed content to the devices 128-131 through a public data network such as the Internet 127 or a mobile broadband network and/or data service provider network. The mobile broadband network is typically a 3G (third generation) or 4G (fourth generation) mobile broadband network.

The streamed video from the source 100 is generally transferred with HTTP Live Streaming (HLS) or HTTP Dynamic Streaming (HDS), in specific examples. HLS is a HTTP-based media streaming communications protocol developed by Apple Inc. as part of its QuickTime software system that uses a sequence of HTTP-based file downloads. HDS is a communications protocol by Adobe System Inc. The player may switch between streams of different quality based on the network bandwidth and the computing device's resources.

Generally, the video is streamed using Hypertext Transfer Protocol (HTTP) or Hypertext Transfer Protocol Secure (or HTTPS). HTTPS combines HTTP with the security of Transport Layer Security/Secure Sockets Layer (or TLS/SSL). TLS/SSL are security protocols that provide encryption of data transferred over the Internet.

In a typical implementation, streamed content is accessed with content streaming applications 201 that are installed on the devices 128-131. The content streaming applications are typically are software applications invoked by user of the devices 128-131 to access streamed content hosted by the streaming source 100, for example. In some examples, the content streaming applications 201 provide access to only the content from a particular streaming source. In an alternative embodiment, content streaming applications are general purposes browsers or media players that are installed on the devices 128-131. Examples of the streaming applications include media playing programs such as QuickTime by Apple Corporation, Windows Media Player by Microsoft Corporation, iTunes by Apple Corporation, or Winamp media player by Nullsoft, Inc., to list a few examples.

In the illustrated example, device 1 128 is functioning as the control device. The application program 201 that displays the user interface content provides both a list of available video programs (program guide) 209 and a list of registered devices 210. However, any of the other devices could likewise function as the control device.

In the illustrated example, the program guide 209 includes a series of television programs or other video content that are available to the user 206. In some examples, these programs are live programs that are currently being broadcast by via terrestrial television broadcast sources. In other examples, the programs are recorded and are stored on the video streaming source 100. In still other examples, the programs are content that is made available through the streaming video source 100 such as pay-per-view programs or programs that are available via a paid subscription or simply free to the user, and even user-generated content.

The list of registered devices 210 lists the devices that are registered to the account of the user 206. In the illustrated example, four devices are associated and registered to the user's account.

In the preferred embodiment, the user 206 by controlling the user interface displayed by the application program 201, running on a portable computing device for example, both selects a video program to watch from the list 209 but also selects a target for that video among the devices that are registered to the account of the user 206.

FIG. 1B shows the user control of the user interface of the application program 201 running on device 128. In the illustrated example, the user has selected to watch live program 3 212a. At the same time, or possibly earlier or after selecting the live program 3 212a, the user also selects a target for the video among the available devices in the list of registered devices 210. In the example, the user has selected device 3 130 as the target device. In other examples, the user could select device 4, which is not on the same local network 208.

As a result of this selection, the video of the live program 212a is displayed on device 3 130. Specifically, the application program 201 running on device 3 130 includes a video window 212b that displays the video associated with the selected program 212a.

In this way, the user is able to use any registered devices to both select the video to watch and also the device on which the video is displayed. The control happens in the cloud, or in the Internet streaming video source 100. So in one concrete example, the user can use a mobile phone essentially as a remote control. Importantly, however, the mobile phone does not need any special purpose software or hardware. Instead it can run a common application program 201, which can even be a standard Internet browser. The user is not required to perform any or possibly only very little configuration on their local network. Instead, the devices only need to be Internet accessible or at least able to access the streaming video source 100. The intelligence required to connect to and control each one of the devices 128-131 is resident in the streaming video source 100.

As illustrated in FIG. 1C, once the video is displayed on device 3 130, in window 212b of the application program 201, the application program 201 running on device 1 128 displays a user interface for the video control of the program playing on device 3 130. Specifically, the user interface provides, displayed on device 1 128, includes rewind, pause/play, fast-forward, and stop/return functions that control and affect the video displayed on device 3 130 in application program window 212b. In this way, device 1 128 continues to be used to control the video that is displayed on device 3 130.

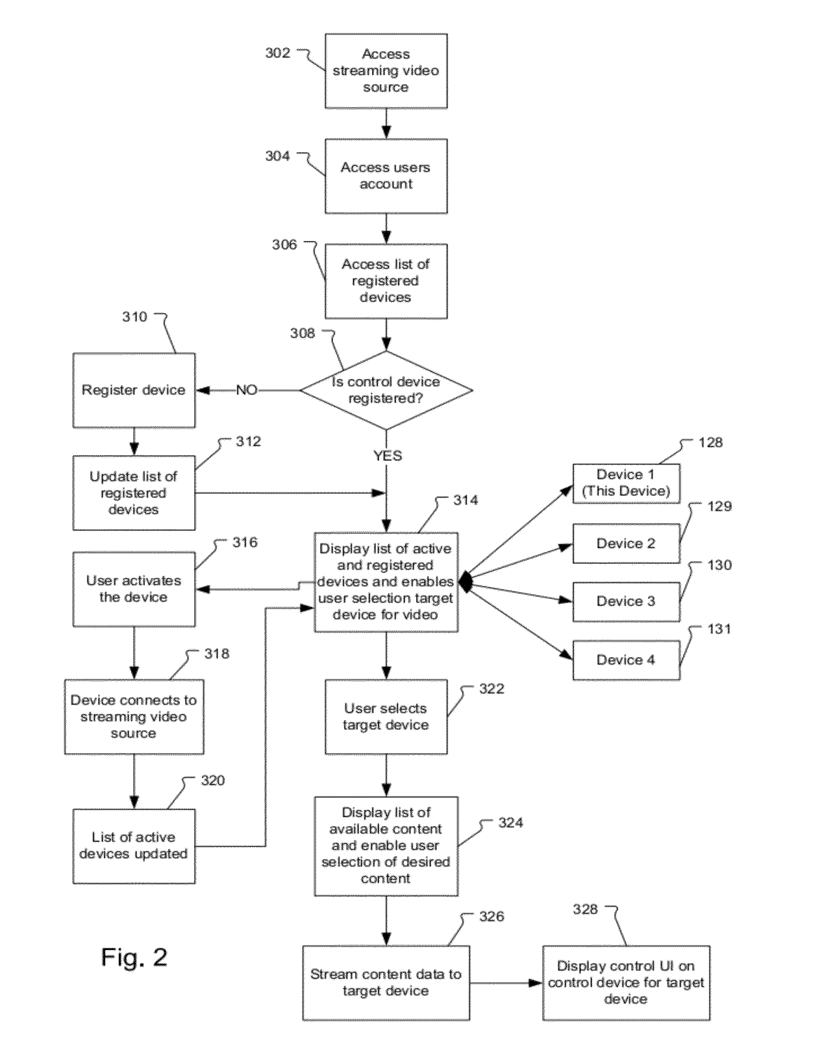

FIG. 2 is a flow diagram illustrating the operations performed by the streaming video source 100 to enable the control of the target device by the control device.

In more detail, the streaming video source 100 is accessed usually by the client device that will function as the control device in step 302. The user, on the control device, must then access their account in step 304. In the next step 306, the streaming 100 accesses a list of registered devices of the user. In the current embodiment, the streaming video source 100 determines whether the device that is currently accessing the user's account is a device that is registered to that user. In the case that the device is not registered, as determined in step 308, then the device is assessed to determine its native resolution, the application program (player) 201 that is running on the device, along with the device's address including its Internet IP address. This information is used to add the device to the list of registered devices in step 310, which is associated with the user's account. In the next step 312, the streaming video source 100 updates the list of registered devices of the user.

Once the device is registered, if required, then in step 314, the list of active and registered devices 210 associated with the user's account is displayed on the application program 201 on the control device 128. This requires the streaming video source to interrogate the status of each of the devices 128-131.

Some registered devices may not be active. The inactive device could be, for example, a portable computer or television that is powered off. In the case that a target device is not active, the user can go through a process of activating their intended target device in step 316. Once activated, the target device connects to the streaming video source 100 in step 318. Typically, activation of the target device further requires invoking a software application, such as a media player or browser, on the target device. The software application establishes a connection with the streaming video source 100 to enable communication between the streaming video source 100 and target device. In the next step 320, the list of registered and active devices 210 is updated on the control device.

In one example, the streaming video source 100 pings or interrogates each of the devices 128-131 to determine whether the devices are active and are able to respond to the streaming video source's ping.

In another example, the user must manually activate the target devices 128-131 to enable the devices establish connections to the streaming video source 100. The target devices 128-131 must establish these connections to alleviate problems created by use of a firewall functionality and/or NAT provided by the router 205 on the local network 208.

In more detail, the non-routable IP addresses assigned to the client devices 128-131 by the router 205 are generally not permanent. The non-routable IP address assignments typically only last for as long as the client devices are powered and connected to the local network. Furthermore, the non-routable IP addresses are often assigned sequentially. As new client devices join the local network they are usually assigned the next available non-routable IP address in the sequence. Similarly, as devices are removed from the local network, their IP addresses become available. The available non-routable IP addresses are then reassigned to other devices joining the local network. Thus, it is common to have multiple client devices switching between the same non-routable IP addresses on a local network. Moreover, the router's firewall is designed to protect networks against threats and/or unauthorized connection attempts to devices on the network. So, generally, the streaming video source cannot initiate a connection to the target device.

By manually activating the target device and enabling the target device to establish a connection with the streaming video source 100, the streaming video source 100 is able to send streaming video to the target device.

In another example, the target devices continually ping or maintain a connection, for example a TCP/IP session, to the streaming video source 100 through the router 205 to maintain an active connection with the streaming video source 100. This is generally accomplished with a software application executing on the target devices 128-131. Typically, the software application operates in the background and uses minimal resources of the target devices 128-131. Enabling the target devices to maintain the active connections with the streaming video source 100 alleviates the issues created with NAT and the firewalls because the translation table of the router 205 is current and the active connection always maintained through the firewall.

In a typical implementation, both methods can operate in tandem. Thus, whenever possible the devices attempt to maintain a connection by continually pinging the streaming video source 100. If the connection to the streaming video source 100 ever fails, then the user manually activates the device.

Next, in step 322, the user selects one of the registered and active devices to be the target device 130 on which any video is to be displayed. In one example, the control device will also be the target device. That is, the user may select the control device as the target device to receive and display the video from the streaming video source 100.

In step 324, a list of available content 209 is displayed for the user on the control device 128. The user can then select a television program, live or recorded, or other video content that will be displayed on the target device 130. This selected content is then streamed to the target device 130 in step 326. At the same time, a control user interface is displayed on the target device 128 to control the video that is being displayed on the target device 130 in step 328.

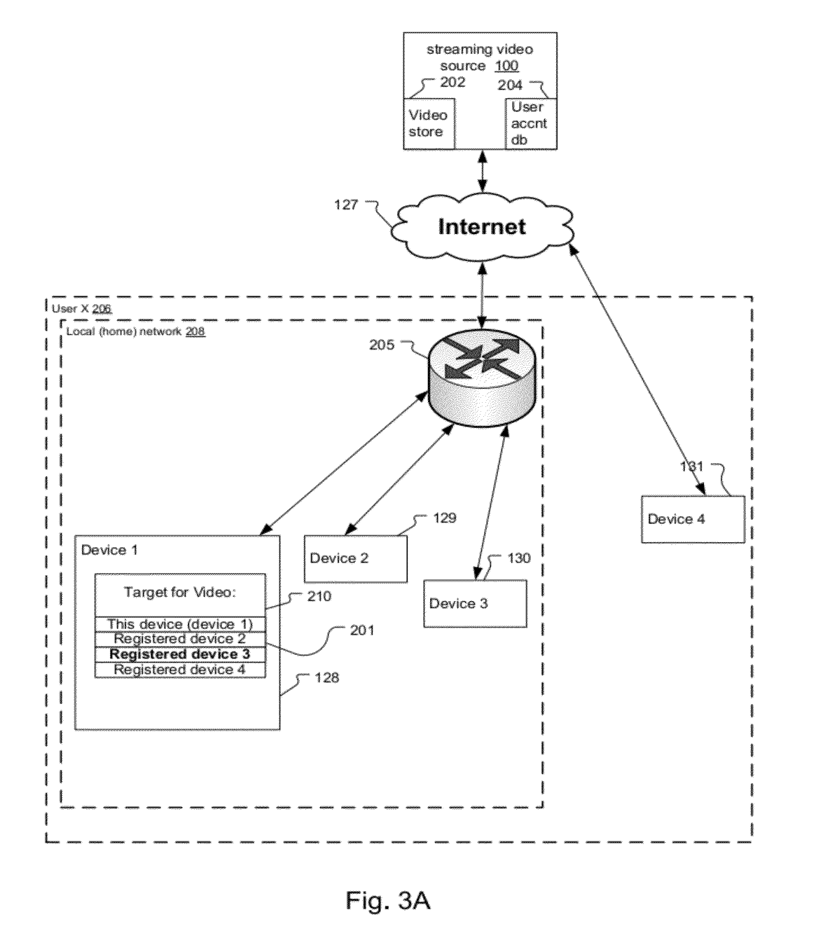

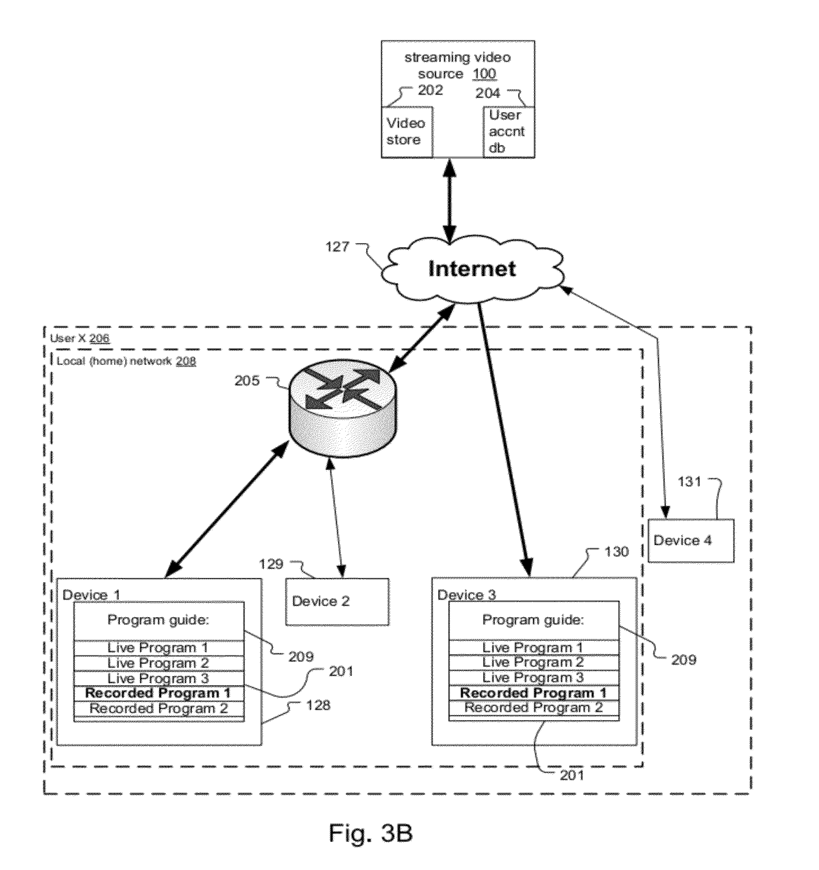

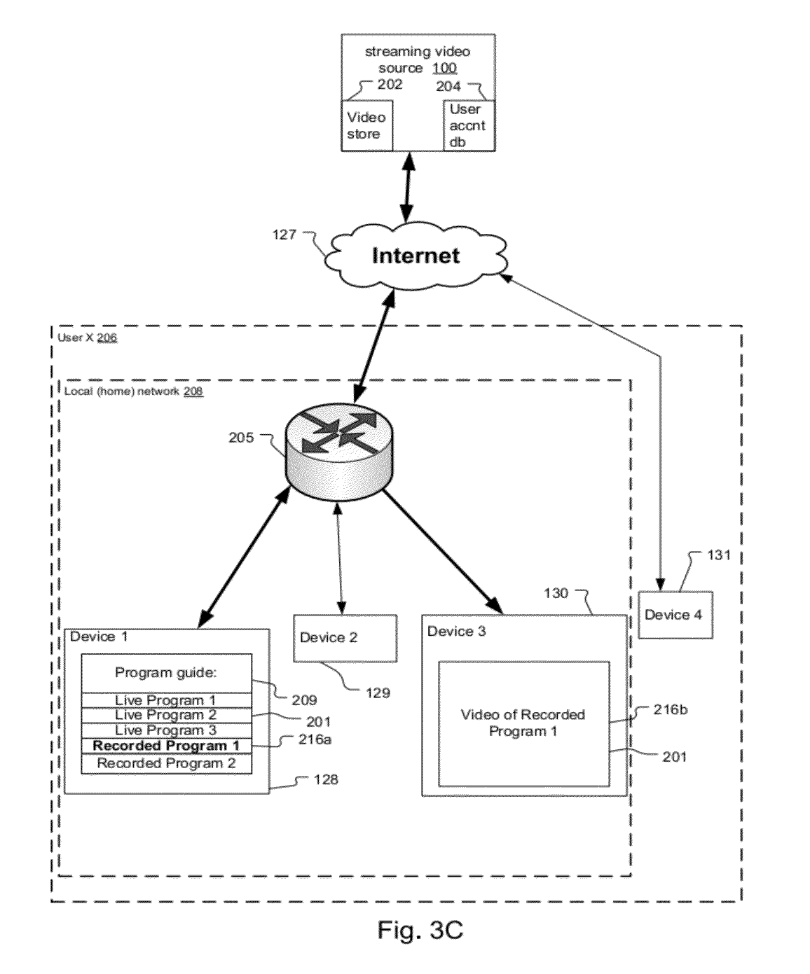

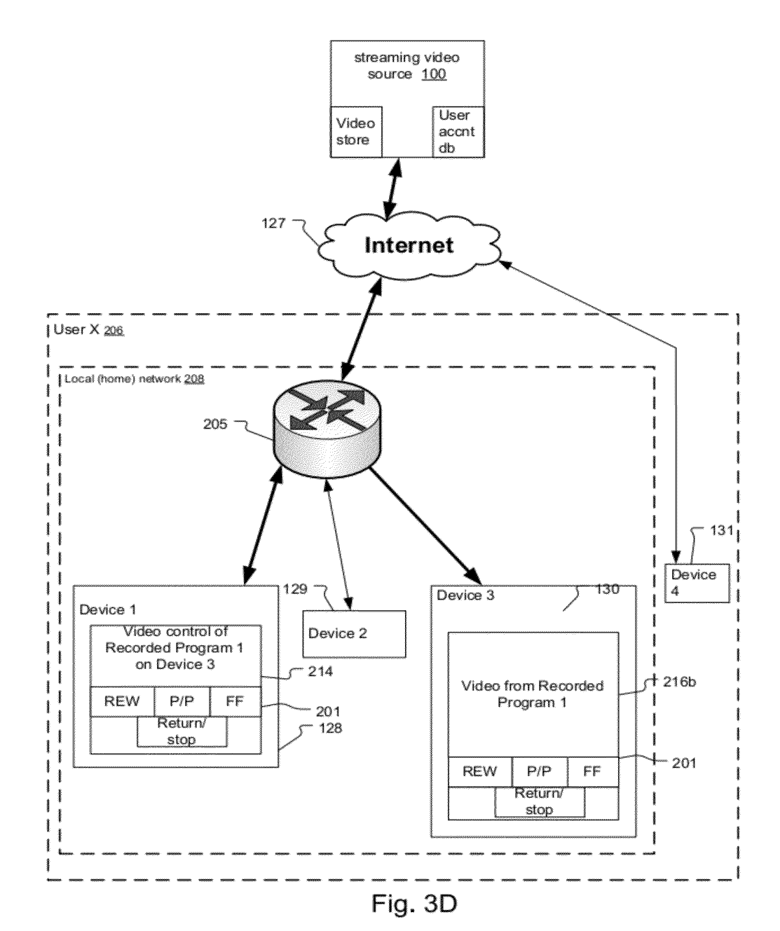

FIGS. 3A through 3D illustrate a technique for both streaming video to a target device under control of a control device while also allowing a user to share any information that is displayed on the user interface of the control device. In a specific example, the user interface displayed on the control device 128 is mirrored on the target device 130.

In more detail, as illustrated in FIG. 3A, device 1 128 again functions as the control device. Device 3 130 will function as the target device, in the specific illustrated example.

In other examples, the control device 128 and the target device 132 do not even share a common local area network, since the control and intelligence required to stream the video resides in the streaming video source 100.

As illustrated, the user interface of the application program 201 executing on the control device 128 displays a list of registered and active devices 210 that are associated with the account of user X 206.

As illustrated in FIG. 3B, with the selection of device 3 as a target device, the user interface displayed by the application program 201 on the control device 128 is mirrored to and displayed by the application program 201 of device 3 130.

The mirroring of the user interface from device 1 128 to device 3 130 allows for the viewers of the display of the target device 130 to see a common list of available video, for example. This facilitates communication among those individuals as to which television program, for example, they want to collectively view.

In the preferred embodiment, activity and control of the user interface on device 1 128 is mirrored on the display of device 3 130. Specifically, selection of recorded program 1 in the list 209 is mimicked on the display of device 3 130. Further, in the preferred embodiment, any scrolling on the program guide 209 is similarly carried through on the display of the program guide 209 on the target device 130.

As illustrated in FIG. 3C, selection of recorded program 1 from the list 209 of available video that is displayed by the application program 201 on device 1 128 results in the end of the UI mirroring on to the target device 130. Instead, the application program 201 of the target device 130 now displays the video associated with the selected video in the player window 216b on the display of the target device 130.

Next, as illustrated in FIG. 3D, once the video has started, the video control user interface is now displayed on the control device 128 by the application program 201. In one example, the control window is also provided on target device 130 by its application program 201. This allows for the situation in which the target device 130 also has the ability to receive user input. Thus the user can now control the video either indirectly via the control device 128 or directly via the target device 130.

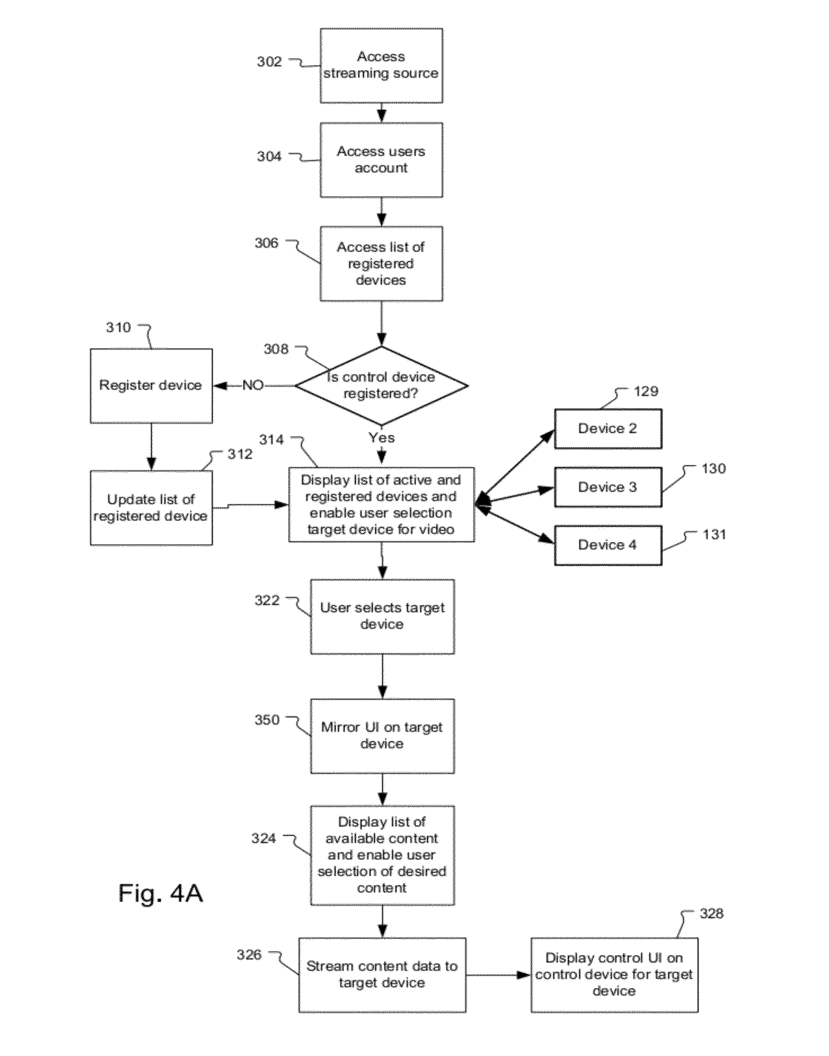

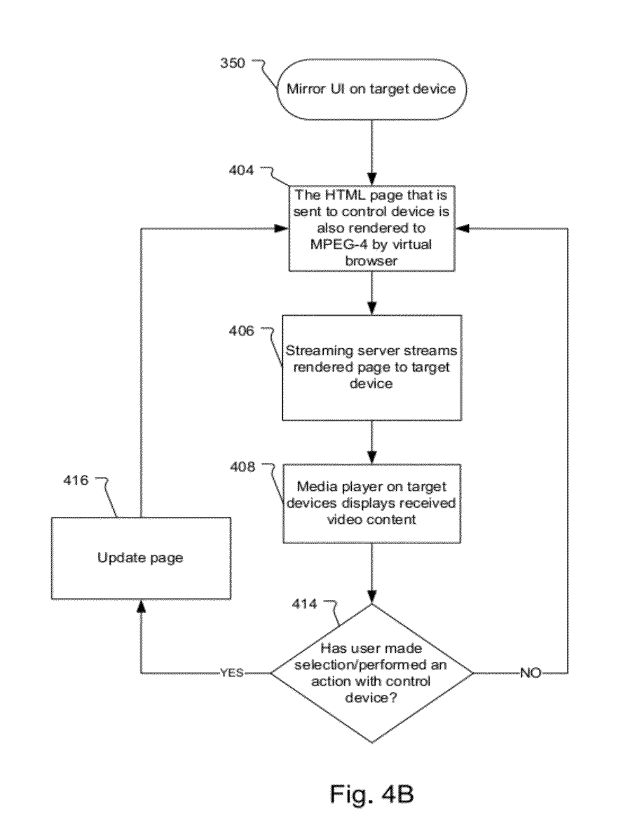

FIG. 4A is a flow diagram illustrating the steps associated with the second embodiment that provides for the mirroring of the user interface of the control device 128 onto the target device 130.

In more detail, after the display of the list of active and registered devices and enabling user selection of a target device and the video in step 314, the user interface on the control device 128 is mirrored and displayed on the display of the target device 130 in step 350.

Thus, when the list of available content 209 is displayed, individuals viewing either the display on the control the vice 128 and/or the display on the target device 130 will then see a common display of the list of available content 209, thus allowing them to communicate at as to what program they wish to view.

FIG. 4B is a flow diagram illustrating the steps for mirroring the user interface of the control device 128 on the target device 130.

In the first step 404, the HTML page that is sent to control device is also rendered to MPEG-4 and AAC by the virtual browser. Next, in step 406, a streaming server streams the rendered page to the target device 130. In the next step 408, the application program 201, such as a media player running on the target device, displays the received video content on the target device 130.

In the next step 414, the source 100 determines if the user made a selection and/or performed an action with the control device. If the user has not performed any actions, then the same HTML page continues to be rendered to MPEG-4 by the virtual browser in step 404.

If the user made a selection or performed an action with the control device, then the page is updated in step 416. In the next step 404, the new HTML page that is sent to control device is also rendered to MPEG-4 by the virtual browser.

In one example, the video streaming source 100 is based on the system described in the incorporated application entitled System and Method for Providing Network Access to Antenna Feeds, filed by the present inventors. That system is now described by way of overview and to also illustrate how the user interface of the control device 128 is mirrored on to the target device 130.

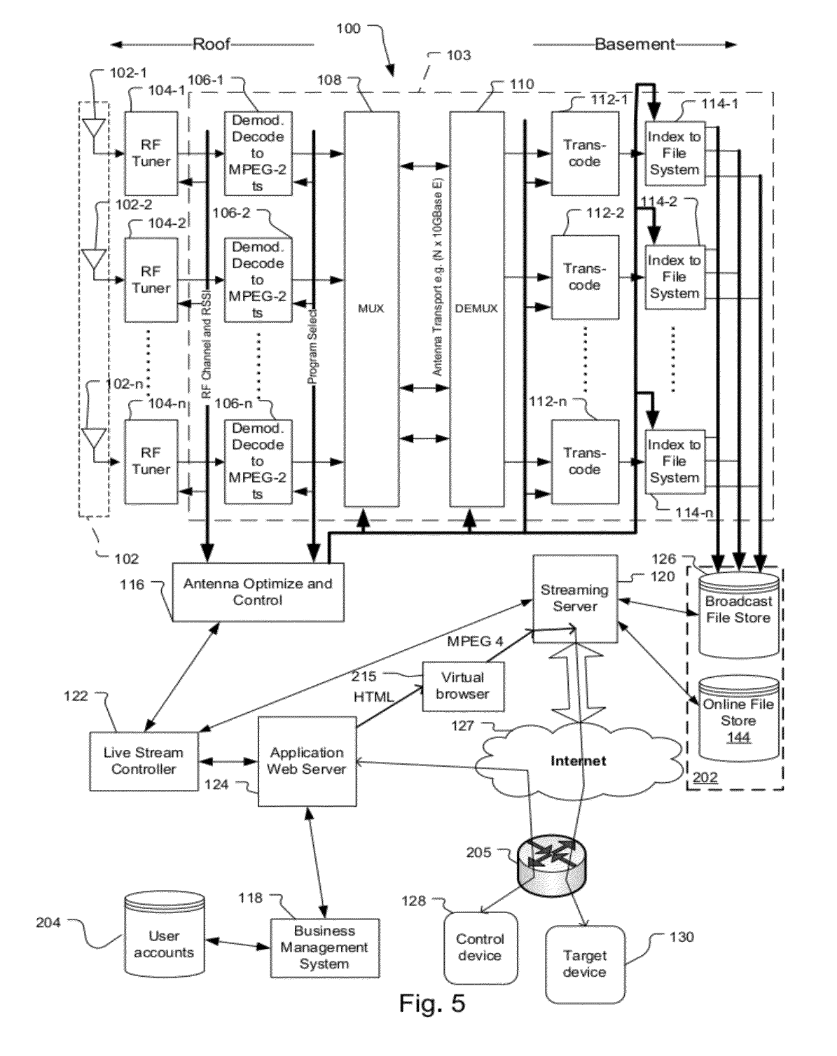

FIG. 5 shows streaming video source based on an antenna capture and video distribution system or platform 100 to which the present invention is applicable in one example.

Individual users to receive terrestrial television content transmissions from antennas via a router 205 and packet network such as the Internet 127. The system allows each user to separately access the feed from an antenna for recording or live streaming.

An application web server (or application server) 124 manages requests or commands from the client devices 128-131. The application server 124 provides the list of available video 209 and allows the users on the client devices 128-131 to select whether they want to access previously recorded content, i.e., a television program, set up a future recording of a broadcast of a television program, or watch a live broadcast television program. A business management system 118 is used to verify the users' accounts or help users set up new accounts if they do not yet have one and it also maintains the list of registered devices 210 for the accounts of the users in the user database 204.

The video store 202 stores the content data associated with the video that is streamed to the devices 128-131. Video from previously recorded content transmissions is stored in a broadcast file store 126. To access it, the application server 124 sends the users' command to a streaming server 120 and live stream controller 122. The live stream controller 122 locates the requested content.

In some embodiment, streamed content data are provided by an online file store 144 that is also part of the video store 202. The content data in the online file store 144 are generally additional videos or content transmissions such as on-demand movies, other licensed content such as television programs, or user files that were uploaded to the online file store 144, to list a few examples.

If the users request to set up future recordings or watch a live broadcast of content transmissions such as television programs, the application server 124 communicates with the live stream controller 122, which instructs the antenna optimization and control system 116 to configure broadcast capture resources to capture and record the desired broadcast content transmissions by reserving antenna and encoding resources for the time and date of the future recording.

On the other hand, if the users request to watch live broadcast content transmissions, then the application server 124 passes the requests to the live stream controller 122 which then instructs the antenna optimization and control system 116 to locate available antenna resources ready for immediate use.

In current embodiments, streaming content is temporarily stored or buffered in the streaming server 120 and/or the broadcast file store 126 prior to streaming to the target device whether for live streaming or future recording. This buffering allows users to pause and replay parts of the television program and also have the program stored to be watched again.

The broadcast capture portion of the system 100 includes an array 102 of antenna elements 102-1, 102-2 . . . 102-n. Each of these elements 102-1, 102-2 . . . 102-n is a separate antenna that is capable of capturing different terrestrial television content broadcasts and, through a digitization and encoding pipeline, separately process those broadcasts for storage and/or live streaming to the target devices. This configuration allows the simultaneous recording of over the air broadcasts from different broadcasting entities for each of the users. In the illustrated example, only one array of antenna elements is shown. In a typical implementation, however, multiple arrays are used, and, in some examples, the arrays are organized into groups.

In more detail, the antenna optimization and control system 116 determines which antenna elements 102-1 to 102-n within the antenna array 102 are available and optimized to receive the particular over the air broadcast content transmissions requested by the users.

After locating an antenna element, the antenna optimization and control system 116 allocates the antenna element to the user. The antenna optimization and control system 116 then signals the corresponding RF tuner 104-1 to 104-n to tune the allocated antenna element to receive the broadcast.

The received broadcasts from each of the antenna elements 102-1 to 102-n and their associated tuners 104-1 to 104-n are transmitted to an encoding system 103 as content transmissions. The encoding system 103 is comprised of encoding components that create parallel processing pipelines for each allocated antenna 102-1 to 102-n and tuner 104-1 to 104-n pair.

The encoding system demodulates and decodes the separate content transmissions from the antennas 102 and tuners 104 into MPEG-2 format using an array of ATSC (Advanced Television Systems Committee) decoders 106-1 to 106-n assigned to each of the processing pipelines. In a situation where each broadcast carrier signal contains multiple content transmissions, the antenna optimization and control system 116 signals the ATSC decoders (or demodulators) 106-1 to 106-n to select the desired program contained on the carrier signal. The content transmissions are decoded to MPEG-2 content transmission data because it is currently a standard format for the coding of moving pictures and associated audio information.

The content transmission data from the ATSC decoders 106-1 to 106-n is sent to a multiplexer 108. The content transmissions are then transmitted across an antenna transport interconnect to a demultiplexer switch 110. In a preferred embodiment, the antenna transport interconnect is an nx10GbE optical data transport layer.

In the current implementation, the antenna array 102, tuners 104-1 to 104-n, demodulators 106-1 to 106-n, and multiplexer 108 are located outside in an enclosure such as on the roof of a building or on an antenna tower.

The multiplexer 108, demultiplexer switch 110, and nx10GbE data transport are used transmit the captured content transmission data to the remainder of the system that is preferably located in a secure location such as a ground-level but or the basement of the building, which also usually has a better controlled ambient environment.

The content transmission data of each of the antenna processing pipelines are then transcoded into a format that is more efficient for storage and streaming. In the current implementation, the transcode to the MPEG-4 (also known as H.264) format is effected by an array of transcoders 112-1 to 112-n. Typically, multiple transcoding threads run on a single signal processing core, SOC (system on a chip), FPGA or ASIC type device.

The content transmission data are transcoded to MPEG-4 format to reduce the bitrates and the sizes of the data footprints. As a consequence, the conversion of the content transmission data to MPEG-4 encoding will reduce the picture quality or resolution of the content, but this reduction is generally not enough to be noticeable for the average user on a typical reduced resolution video display device. The reduced size of the content transmissions will make the content transmissions easier to store, transfer, and stream to the target devices. Similarly, audio is transcoded to AAC in the current embodiment, which is known to be highly efficient.

In one embodiment, the transcoded content transmission data are sent to a packetizers and indexers 114-1, 114-2 . . . 114-n of the pipelines, which packetize the data. In the current embodiment, the packet protocol is UDP (user datagram protocol), which is a stateless, streaming protocol. UDP is a simple transmission model that provides less reliable service because datagrams may arrive out of order, duplicated, and go missing. Generally, this protocol is preferred for time-sensitive transmission, such as streaming files, where missing or duplicated packets can be dropped and there is no need to wait for delayed packets

Also, in this process, time index information is added to the content transmissions. The content data are then transferred to the broadcast file store 126 for storage to the file system, which is used to store and/or buffer the content transmissions as content data for the various television programs being captured by the users.

There are a couple of options for mirroring the user interface of the control device 128 on the target device 130. In one implementation, the application server 124 generates HTML webpages that are rendered by browser application program 201 that run on the control device 128. This HTML data are also transmitted to the target device 130 and rendered by a browser application program 201 that similarly runs on the target device 130.

This approach, however, is not the preferred in all instances. The reason is that often the target device 130 will be a television. Not all televisions have been embedded browsers that can receive and render the HTML data that are generated by the application Web server 124.

As a result, in another implementation, the HTML data, which are sent to the control device 128 to be rendered by a browser running on the control device, are also sent to a virtual browser 215 within the system 100 that runs on the application server 124 or streaming server, 120, for example. The virtual browser 215 receives the HTML data from the application server 124, renders the HTML data and then generates an MPEG 4 encoded video stream. This video stream is sent to the streaming server 120 and then streamed to the target device 130. In this way, the target device does not need to have a browser that can render HTML data. It only needs to have the ability to render MPEG 4 video, which can be provided by a standard video player running on the television or a streaming media device connected to the television. The target device simply does not know the difference between MPEG-4 video of a streamed program and the MPEG 4 video that results from rendering the HTML data by the virtual browser 215. This allows user interface mirroring even when the target device lacks the ability to render the user interface from HTML data.

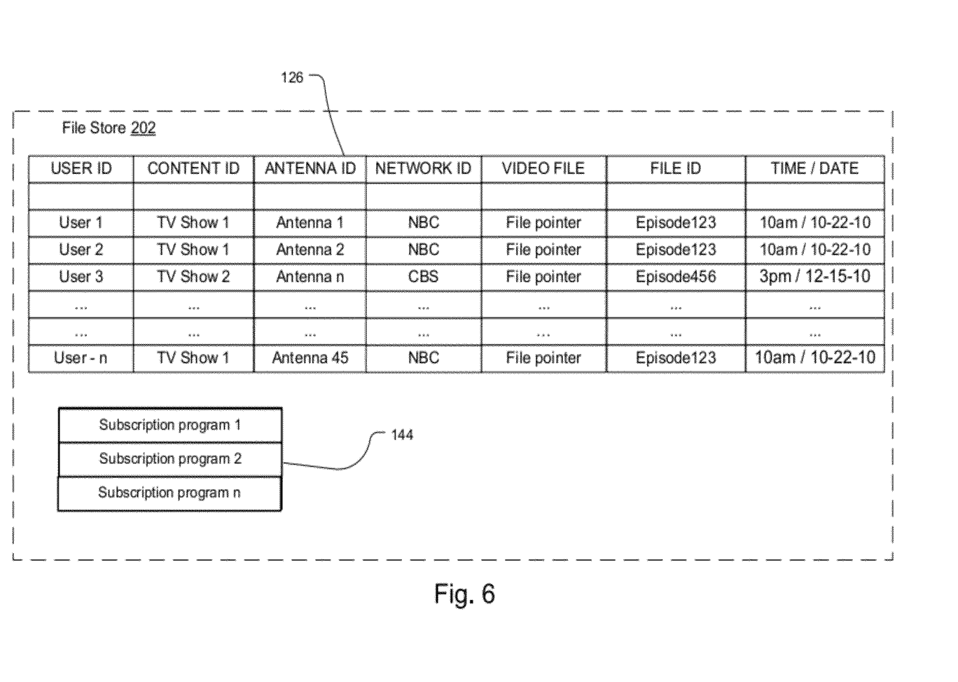

FIG. 6 illustrates the database architecture for storing content data from content transmissions in the file store 202.

In the illustrated example, each record in the broadcast file store 126 includes information that identifies the user and the transcoded content data. For example, a user identification field (USER ID) uniquely identifies each user and/or their individual user account. Additionally, every captured content transmission is associated with the user that requested it. The content identification field (CONTENT ID) identifies the title (or name) of the content transmission. Generally, the content name is the title of the television program, television show or movie, that is being recorded or streamed live. An antenna identification field (ANTENNA ID) identifies the specific antenna element that was assigned and then used to capture the content transmission. A network identification field (NETWORK ID) specifies the broadcasting entity or network that broadcast the content transmission. The video file field (VIDEO FILE) contains the content data or typically a pointer to the location of this data. The pointer specifies the storage location(s) of the high, medium, and low quality content data. A file identification field (FILE ID) further indentifies the unique episode, movie, or news broadcast. Lastly, a time and date identification field (TIME/DATE) stores the time and date when the content transmission was captured. In alternative embodiments, records in the broadcast file store 126 could include greater or fewer fields.

By way of an example, User 1 and User 2 both have unique USER ID's and both have their own individual copies of content transmissions even though both users requested the same program at the same time and date, and on the same broadcast network. User 1 is only able to view their copy of content data stored to their USER ID and User 2 is only able to view their copy of the content data stored to their USER ID. Additionally, the unique antenna element that was assigned to each user is also recorded in the ANTENNA ID field.

The file store 202 also includes other online content 144 that is available to users such as programs 1-program n that are available by subscription or on a pay-per-view basis or free.

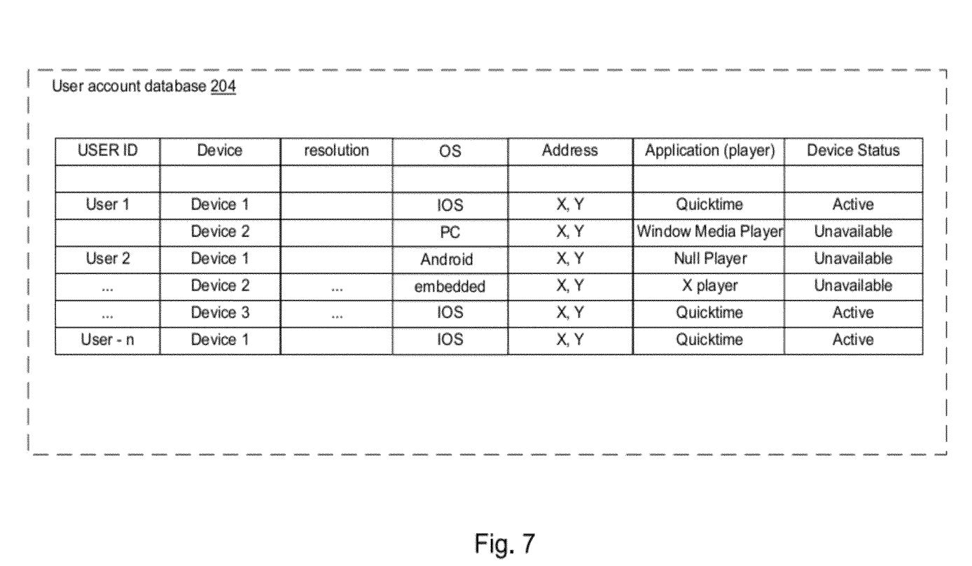

FIG. 7 illustrates the architecture for the user account database 204. This stores the information associated with each user, user 1-user n. For each user, there is a list of their registered devices. In one example, the database 204 further stores the native resolution of those devices, their operating systems, and their Internet protocol (IP) addresses. In this way, for each user account, the system is able to keep track of that user's registered devices, the protocols required to access that user's devices, a specific application programs 201 that are running on those devices for the display of the video, along with the address for connecting to those devices and thus to stream video to the application programs 201 that run on the devices. Finally, the status of the devices, active or unavailable is also maintained in the database 204.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for program and stream control of video, comprising:
displaying on devices, which are registered to accounts of users of a streaming video source, lists identifying video that is available to the users;
enabling the users of the devices to select from the available video and to select target devices on which the selected video is to be displayed; and
the streaming video source sending the selected video to the selected target devices.

2. The method according to claim 1, wherein selection of the target devices is from lists of registered devices corresponding to accounts of the users.

3. The method according to claim 2, wherein the lists of registered devices are based on the devices associated with the accounts of the users.

4. The method according to claim 2, further comprising enabling the users to add new devices to the lists of registered devices when accessing the streaming video source.

5. The method according to claim 1, further comprising displaying user selectable video controls on the devices to enable the devices to control display of the selected video on the target devices.

6. The method according to claim 1, further comprising mirroring user interface content displayed on control devices, including the lists of available video, to the target devices.

7. The method according to claim 6, wherein the user interface content is converted to a streaming video format and then streamed to the target devices.

8. The method according to claim 1, wherein the selected video is from content transmissions that were received by an antenna capture and distribution system.

9. The method according to claim 1, wherein the selected video is from a streaming media service.

10. The method according to claim 1, wherein the lists of available video identifying video that is available to the users is a television program guide.

11. The method according to claim 1, wherein control devices and the target devices are on common local area networks, on which both devices are clients.

12. The method according to claim 1, further comprising the target devices continually communicating with the streaming video source to maintain active connections between the target devices and the streaming video source.

13. The method according to claim 12, wherein the streaming video source identifies the target devices that are available for selection based on the active connections between the target devices and the streaming video source.

14. A system for program and stream control of video, comprising:
a streaming video source that provides streaming video, the streaming video source maintaining accounts for users in which registered devices of the users are associated with each of the accounts;
target devices, which are registered devices, on which the streaming video is displayed; and
control devices, which are registered devices, from which the users select the streaming video and the target devices.

15. The system according to claim 14, wherein the control devices display lists of registered devices corresponding to the accounts of the users.

16. The system according to claim 15, wherein the lists of registered devices are based on the devices associated with the accounts of the users.

17. The system according to claim 14, wherein the control devices display user selectable video controls to enable control of display of the selected video on the target devices.

18. The system according to claim 14, wherein the streaming video source mirrors user interface content displayed on the control devices, including the lists of available video, to the target devices.

19. The system according to claim 18, wherein the streaming video source converts the user interface content into a streaming video format and then streams the user interface content to the target devices.

20. The system according to claim 14, wherein the streaming video source generates the selected video from content transmissions that were received by an antenna capture and distribution system.

21. The system according to claim 14, wherein the streaming video source provides the selected video from a streaming media service.

22. The system according to claim 14, wherein the lists of available video identifying video that is available to the users is a television program guide.

23. The system according to claim 14, wherein control devices and the target devices are on common local area networks, on which both devices are clients.

24. The system according to claim 14, wherein the target devices communicate with the streaming video source to maintain active connections between the target devices and the streaming video source.

25. The system according to claim 24, wherein the streaming video source identifies the target devices that are available for selection based on the active connections between the target devices and streaming video source.
